(19) United States
(12) Patent Application Publication
(10) Pub. No.: US 2021/0181575 A1
(43) Pub. Date: Jun. 17, 2021

(54) REFLECTIVE DISPLAY PANEL AND MANUFACTURING THEREOF, AND DISPLAY DEVICE

(71) Applicants: Beijing BOE Display Technology Co., Ltd., Beijing (CN); BOE Technology Group Co., Ltd., Beijing (CN)

(72) Inventors: Mingxuan Liu, Beijing (CN); Huibin Guo, Beijing (CN); Xiaoxiang Zhang, Beijing (CN)

(21) Appl. No.: 16/077,102

(22) PCT Filed: Feb. 13, 2018
(86) PCT No.: PCT/CN2018/076719

§ 371 Date: Aug. 10, 2018

(30) Foreign Application Priority Data
Mar. 3, 2017 (CN) 201710124566.9

(51) Int. Cl. G02F 1/1335; G02F 1/1368; G02F 1/1362

(52) U.S. Cl. CPC G02F 1/133553; G02F 1/133531; G02F 1/136222; G02F 1/133618; G02F 1/1368

(57) ABSTRACT

A reflective display panel (1), a manufacturing method thereof and a display device are provided. The reflective display panel (1) includes a first base substrate (11) and a second base substrate (12) which are oppositely arranged. A reflecting layer (13) is arranged at a side, close to the second base substrate (12), of the first base substrate (11), and a thin film transistor (14) and a lead (15) are arranged at a side, close to the first base substrate (11), of the second base substrate (12), which solves the problems of requiring more housing materials to be used when the reflective display panel (1) is packaged, as well as causing the waste of housing materials and impossibility of achieving the frameless display side of the reflective display panel (1), thereby reducing the waste of housing materials and achieving the frameless display side of the reflective display panel (1).

This application is a 371 of PCT Patent Application Serial No. PCT/CN2018/076719, filed on Feb. 13, 2018, which claims priority to Chinese Patent Application No. 201710124566.9, filed with the State Intellectual Property Office on Mar. 3, 2017 and titled “REFLECTIVE DISPLAY PANEL AND MANUFACTURING METHOD THEREOF, AND DISPLAY DEVICE”, the entire contents of which are incorporated herein by reference.

### TECHNICAL FIELD

The present disclosure relates to a reflective display panel, a manufacturing method thereof and a display device.

### BACKGROUND

With the development of display technology, various display panels have appeared, among which a reflective display panel may display images without being provided with a backlight source.

In the related art, the reflective display panel may include a first base substrate and a second base substrate which are oppositely arranged, and liquid crystals arranged between the first base substrate and the second base substrate. A thin film transistor and a lead are arranged at the side, close to the first base substrate, of the second base substrate. A reflecting layer is arranged at a side, close to the first base substrate, of the thin film transistor. Herein, the thin film transistor is arranged in a display region on the second base substrate. The lead is arranged in a bonding region on the second base substrate. An orthographic projection region of the first base substrate on the second base substrate coincides with the display region. Ambient light may sequentially pass through the first base substrate and the liquid crystals from the side, away from the second base substrate, of the first base substrate to the reflecting layer on the second base substrate, then is reflected by the reflecting layer, and passes through the liquid crystals and the first base substrate again, and finally exits out of the first base substrate, so that the reflective display panel displays images.

In the related art, a display side of the reflective display panel is a side, away from the second base substrate, of the first base substrate. The orthographic projection region of the first base substrate on the second base substrate does not coincide with the bonding region, and thus the first base substrate cannot completely cover the second base substrate. When the reflective display panel is packaged, it needs to cover edges of the display side, as well as side surfaces and a back surface of the reflective display panel with a housing. Therefore, it needs to use more housing materials when the reflective display panel is packaged, which results in the waste of housing materials and impossibility of achieving the frameless display side of the reflective display panel.

### SUMMARY

There are provided in the present disclosure a reflective display panel, a manufacturing method thereof and a display device.

In a first aspect, there is provided a reflective display panel, comprising: a first base substrate and a second base substrate which are oppositely arranged, wherein a reflecting layer is arranged at a side, close to the second base substrate, of the first base substrate, and a thin film transistor and a lead are arranged at a side, close to the first base substrate, of the second base substrate.

Optionally, the reflective display panel further comprises liquid crystals arranged between the first base substrate and the second base substrate,

wherein a quarter-slide is arranged at a side, away from the first base substrate, of the second base substrate;

a polarizer is arranged at a side, away from the first base substrate, of the quarter-slide; and

an included angle between a light transmission axis of the polarizer and an optical axis of the quarter-slide is 45 degrees, and the optical axis of the quarter-slide is parallel to a long axis of the liquid crystal.

Optionally, the thin film transistor comprises a plurality of functional film layers;

a reflectivity of the functional film layer, close to the second base substrate, in the plurality of functional film layers is lower than reflectivities of the other functional film layers; and the other functional film layers are any of the plurality of functional film layers other than the functional film layer close to the second base substrate.

Optionally, the reflectivity of the functional film layer, close to the second base substrate, in the plurality of functional film layers is lower than 10%.

Optionally, the thin film transistor comprises a plurality of functional film layers; a preset film layer is arranged at the side, close to the first base substrate, of the second base substrate; the thin film transistor and the lead are arranged at a side, close to the first base substrate, of the preset film layer; wherein an orthographic projection region of the thin film transistor on the second base substrate coincides with an orthographic projection region of the preset film layer on the second base substrate; and the reflectivity of the preset film layer is lower than the reflectivity of any of the plurality of functional film layers.

Optionally, the reflectivity of the preset film layer is lower than 10%.

Optionally, a color film layer is arranged at a side, close to the second base substrate, of the reflecting layer; and the liquid crystals are located between the color film layer and the thin film transistor.

Optionally, the second base substrate has a display region and a bonding region;

the thin film transistor is located in the display region; the lead is located in the bonding region;

an orthographic projection region of the first base substrate on the second base substrate is the display region; and the reflecting layer overspreads the first base substrate.

In a second aspect, there is provided a manufacturing method of a reflective display panel, comprising the following steps:

forming a reflecting layer at a side of a first base substrate;

forming a thin film transistor and a lead at a side of a second base substrate; and

arranging the first base substrate and the second base substrate oppositely, such that the reflecting layer is arranged close to the second base substrate, and the thin film transistor and the lead are arranged close to the first base substrate.

Optionally, the method further comprises the following steps after the step of arranging the first base substrate and the second base substrate oppositely:

arranging liquid crystals between the first base substrate and the second base substrate;

arranging a quarter-slide at a side, away from the first base substrate, of the second base substrate; and

arranging a polarizer at a side, away from the first base substrate, of the quarter-slide,

wherein an included angle between a light transmission axis of the polarizer and an optical axis of the quarter-slide is 45 degrees, and the optical axis of the quarter-slide is parallel to a long axis of the liquid crystal.

Optionally, the thin film transistor comprises a plurality of functional film layers;

a reflectivity of the functional film layer, close to the second base substrate, in the plurality of functional film layers is lower than reflectivities of the other functional film layers; and the other functional film layers are any of the plurality of functional film layers other than the functional film layer close to the second base substrate.

Optionally, the reflectivity of the functional film layer, close to the second base substrate, in the plurality of functional film layers is lower than 10%.

Optionally, the thin film transistor comprises a plurality of functional film layers; the step of forming the thin film transistor and the lead at the side of the second base substrate comprises the following steps: forming a preset film layer at the side of the second base substrate, and forming the thin film transistor and the lead on the second base substrate on which the preset film layer is formed; wherein an orthographic projection region of the thin film transistor on the second base substrate coincides with an orthographic projection region of the preset film layer on the second base substrate; and a reflectivity of the preset film layer is lower than the reflectivities of any of the functional film layers in the thin film transistor.

Optionally, the reflectivity of the preset film layer is lower than 10%.

Optionally, the method further comprises the following step after the step of forming the reflecting layer at the side of the first base substrate:

forming a color film layer at a side, away from the first base substrate, of the reflecting layer,

wherein after the step of arranging liquid crystals between the first base substrate and the second base substrate, the liquid crystals are between the color film layer and the thin film transistor.

Optionally, the reflecting layer overspreads the first base substrate; the second base substrate has a display region and a bonding region; after the step of arranging the first base substrate and the second base substrate oppositely, an orthographic projection region of the first base substrate on the second base substrate is the display region; and the step of forming the thin film transistor and the lead at the side of the second base substrate comprises the following steps:

forming the thin film transistor in the display region at the side of the second base substrate, and

forming the lead in the bonding region at the side of the second base substrate.

In a third aspect, there is provided a display device comprising the reflective display panel as described in the first aspect.

Optionally, the display device further comprises a housing and a printed circuit board,

wherein the printed circuit board is connected with the thin film transistor through the lead, and is arranged at a side, away from the second base substrate, of the first base substrate;

an edge of the housing is in contact with a side surface of the second base substrate; and structures between the second base substrate and the printed circuit board as well as the printed circuit board are all located between the housing and the second base substrate.

Optionally, the display device further comprises a housing and a printed circuit board,

wherein the printed circuit board is connected with the thin film transistor through the lead, and is arranged at the side, away from the second base substrate, of the first base substrate;

an edge of the housing is in contact with the surface, close to the first base substrate, of the second base substrate; and structures between the second base substrate and the printed circuit board as well as the printed circuit board are all located between the housing and the second base substrate

Optionally, the display device further comprises a light source,

wherein the light source is arranged at a side, away from the first base substrate, of the second base substrate and is configured to emit light to the reflective display panel.

### BRIEF DESCRIPTION OF THE DRAWINGS

FIG. 1 is a schematic diagram of a structure of a reflective display panel according to an embodiment of the present disclosure;

FIG. 2A is a schematic diagram of a structure of another reflective display panel according to an embodiment of the present disclosure;

FIG. 2B is a schematic diagram of a structure of yet another reflective display panel according to an embodiment of the present disclosure;

FIG. 3 is a schematic diagram of a pixel region in an on-state according to an embodiment of the present disclosure;

FIG. 4 is a schematic diagram of a pixel region in a working state according to an embodiment of the present disclosure;

FIG. 5A is a schematic diagram of a pixel region in an off-state according to an embodiment of the present disclosure;

FIG. 5B is a schematic diagram of a partial structure of a reflective display panel according to an embodiment of the present disclosure;

FIG. 5C is a schematic diagram of a partial structure of another reflective display panel according to an embodiment of the present disclosure;

FIG. 6 is a flowchart of a manufacturing method of a reflective display panel according to an embodiment of the present disclosure;

FIG. 7 is a flowchart of another manufacturing method of a reflective display panel according to an embodiment of the present disclosure;

FIG. 8A is a schematic diagram of a first partial structure of a reflective display panel according to an embodiment of the present disclosure;

FIG. 8B is a schematic diagram of a second partial structure of a reflective display panel according to an embodiment of the present disclosure;

FIG. 8C is a schematic diagram of a third partial structure of a reflective display panel according to an embodiment of the present disclosure;

FIG. 8D is a schematic diagram of a fourth partial structure of a reflective display panel according to an embodiment of the present disclosure;

FIG. 8E is a schematic diagram of a fifth partial structure of a reflective display panel according to an embodiment of the present disclosure;

FIG. 8F is a schematic diagram of a sixth partial structure of a reflective display panel according to an embodiment of the present disclosure;

FIG. 8G is a schematic diagram of a seventh partial structure of a reflective display panel according to an embodiment of the present disclosure;

FIG. 9 is a schematic diagram of a structure of a reflective display device provided in the related art;

FIG. 10 is a schematic diagram of a structure of a reflective display device according to an embodiment of the present disclosure; and

FIG. 11 is a schematic diagram of a structure of a reflective display device according to an embodiment of the present disclosure.

### DETAILED DESCRIPTION

The present disclosure will be described in further detail with reference to the enclosed drawings, to clearly present the principle and advantages of the present disclosure.

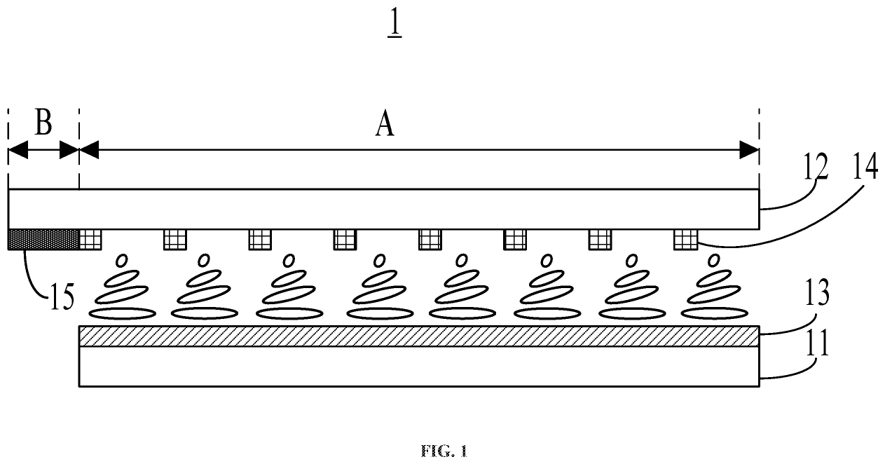

FIG. 1 is a schematic diagram of a structure of a reflective display panel according to an embodiment of the present disclosure. As shown in FIG. 1, the reflective display panel 1 includes: a first base substrate 11 and a second base substrate 12 which are oppositely arranged, a reflecting layer 13 is arranged at a side, close to the second base substrate 12, of the first base substrate 11, and a thin film transistor 14 and a lead 15 are arranged at a side, close to the first base substrate 11, of the second base substrate 12.

To sum up, in the reflective display panel provided in the embodiments of the present disclosure, the reflecting layer is arranged on the first base substrate, and the thin film transistor and the lead are arranged on the second base substrate. Therefore, the display side of the reflective display panel is a side, away from the first base substrate, of the second base substrate. The second base substrate is relatively large in area and may completely cover the first base substrate, thus there is no need to cover the display side of the reflective display panel with a frame when the reflective display panel is packaged, thereby reducing the waste of housing materials and achieving the frameless display side of the reflective display panel.

Exemplarily, the second base substrate 12 may have a display region A and a bonding region B. The thin film transistor 14 may be located in the display region A. The lead 15 may be located in the bonding region B. An orthographic projection region of the first base substrate 11 on the second base substrate 12 may be the display region A, and the reflecting layer 13 may overspread the first base substrate 11.

It should be noted that a plurality of thin film transistors may be arranged on the second base substrate. The plurality of thin film transistors are in one-to-one correspondence with a plurality of pixel regions on the second base substrate. Each of the thin film transistors is located in a pixel region corresponding to the thin film transistor.

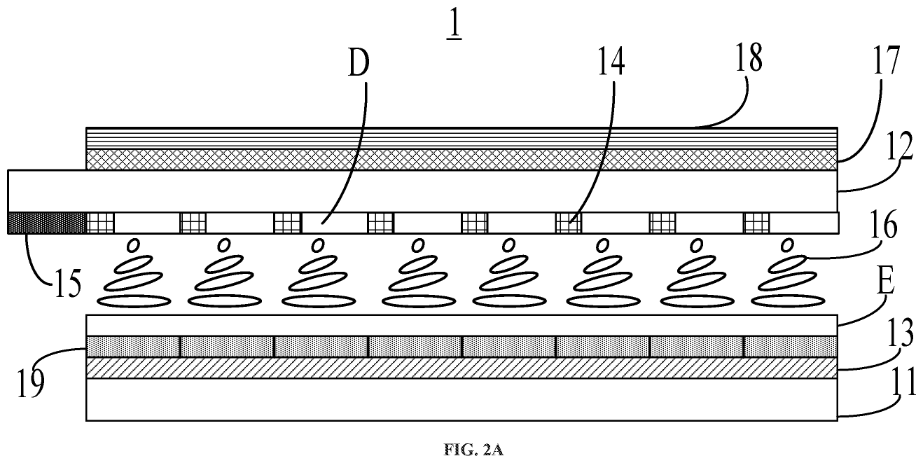

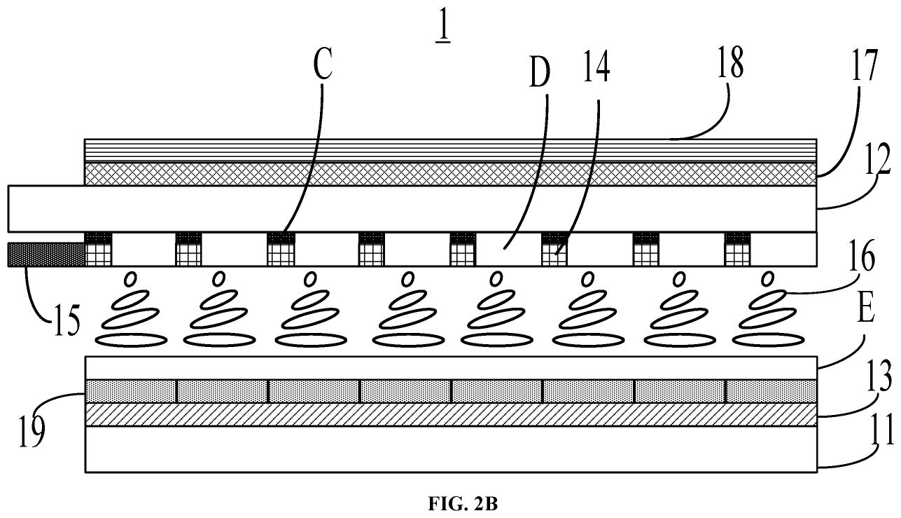

Optionally, FIG. 2A is a schematic diagram of a structure of another reflective display panel according to an embodiment of the present disclosure. As shown in FIG. 2A, on the basis of FIG. 1, the reflective display panel 1 may further include: a quarter-slide 17, a polarizer 18, and liquid crystals 16 arranged between the first base substrate 11 and the second base substrate 12. Herein, the quarter-slide 17 is arranged at a side, away from the first base substrate 11, of the second base substrate 12. The polarizer 18 is arranged at a side, away from the first base substrate 11, of the quarter-slide 17. An included angle between a light transmission axis of the polarizer 18 and an optical axis of the quarter-slide 17 is 45 degrees (that is, an included angle between a length direction of the light transmission axis of the polarizer 18 and a long axis direction of the quarter-slide 17 is 45 degrees). The optical axis of the quarter-slide 17 is parallel to a long axis of the liquid crystal 16 (that is, the long axis direction of the quarter-slide 17 is parallel to the long axis direction of the liquid crystal 16).

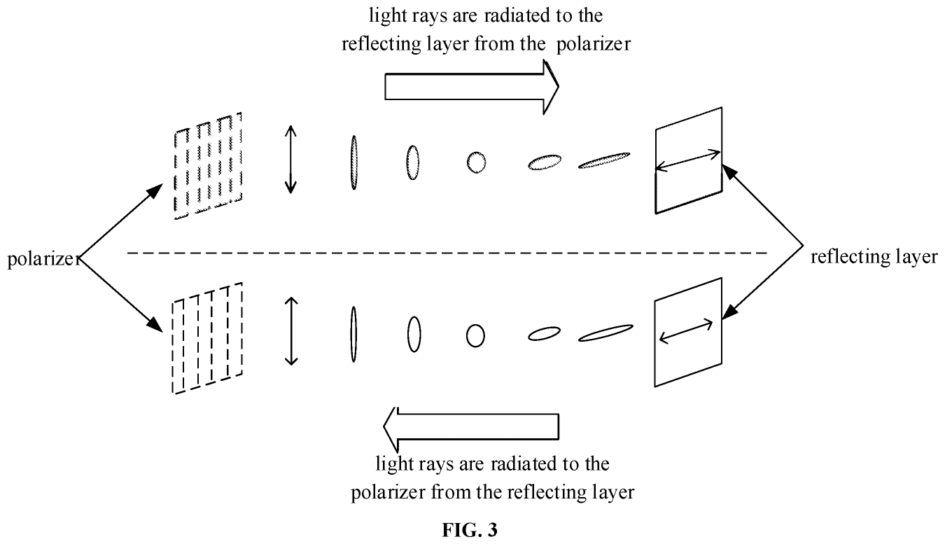

FIG. 3 is a schematic diagram of a pixel region in an on-state according to an embodiment of the present disclosure. As shown in FIG. 3, when it needs to control a certain pixel region to emit light (i.e., on-state: ambient light may be incident on the pixel region and reflected out of the reflective display panel by the pixel region to make the pixel region emit lights), a voltage may not be applied to the liquid crystal corresponding to the pixel region, such that the liquid crystal corresponding to the pixel region does not deflect. In this case, both the quarter-slide and the liquid crystal (not shown in FIG. 3) may change a polarization direction of the light. It should be noted that FIG. 3 only shows the polarizer and the reflecting layer, and patterns between the polarizer and the reflecting layer are used to represent the polarization states of the light.

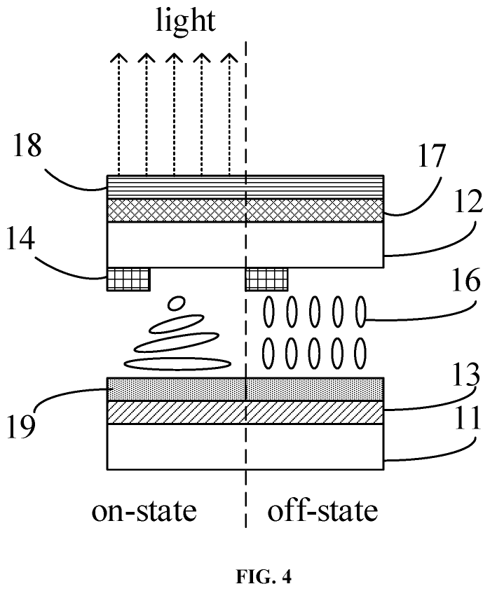

Exemplarily, ambient light is incident on the polarizer, and becomes to linearly polarized light after passing through the polarizer. The linearly polarized light is incident on the quarter-slide and the liquid crystals, and under the phase delay of both the quarter-slide and the liquid crystals, the polarization direction of the linearly polarized light is changed by 90 degrees. In this case, the polarization direction of the linearly polarized light incident on the reflecting layer is different from the polarization direction of the linearly polarized light exiting out of the polarizer by 90 degrees. Further, the linearly polarized light incident on the reflecting layer may be reflected on the reflecting layer and then is incident on the liquid crystals and the quarter-slide again. Under the phase delay of both the liquid crystals and the quarter-slide, the polarization direction of the linearly polarized light is changed by 90 degrees again. In this case, the polarization direction of the linearly polarized light incident on the polarizer is different from the polarization direction of the linearly polarized light exiting out of the polarizer by 180 degrees. That is, the polarization direction of the linearly polarized light incident on the polarizer is parallel to the polarization direction of the linearly polarized light exiting out of the polarizer. The linearly polarized light incident on the polarizer may pass through the polarizer, and then may be emitted from a side, away from the reflecting layer, of the polarizer, such that there is light exiting out of the pixel region, thereby achieving the on-state shown in FIG. 4.

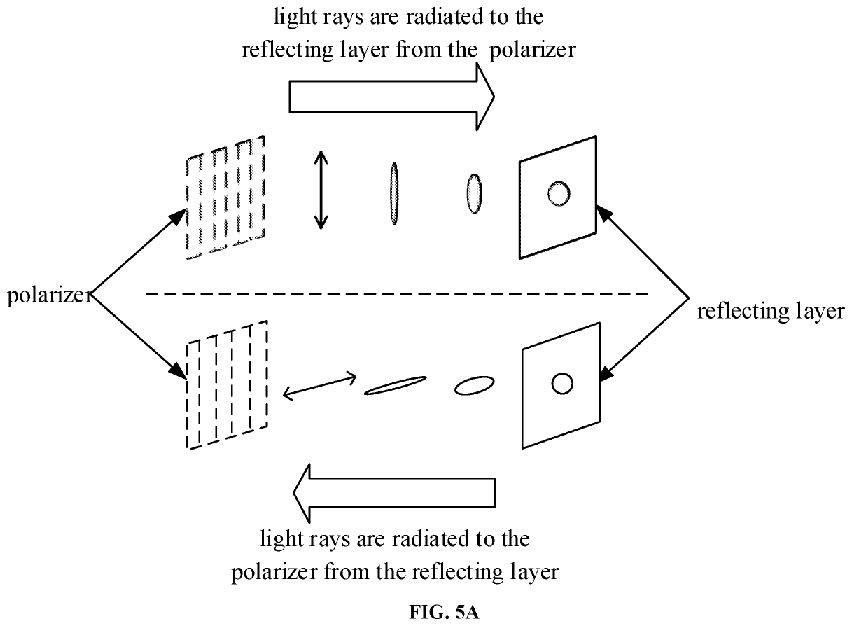

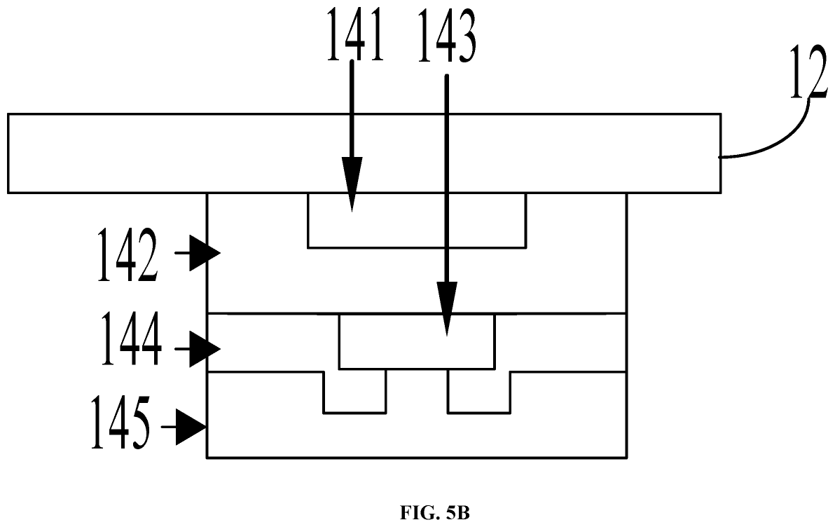

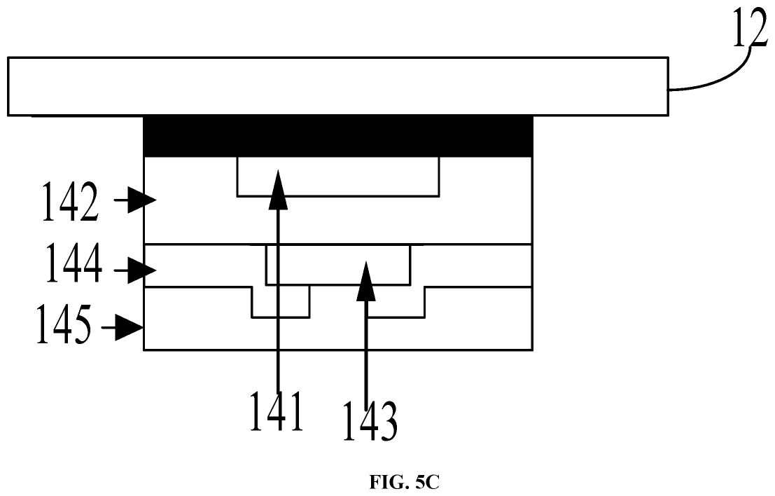

FIG. 5A is a schematic diagram of a pixel region in an off-state according to an embodiment of the present disclosure. As shown in FIG. 5A, when it needs to control a certain pixel region not to emit light (i.e., off-state), a voltage may be applied to the liquid crystal corresponding to the pixel region, such that the liquid crystal corresponding to the pixel region deflects. In this case, the liquid crystal (not shown in FIG. 5A) does not change the polarization direction of the light, but the quarter-slide (not shown in FIG. 5 A) may change the polarization direction of the light. It should be noted that FIG. 5 only shows the polarizer and the reflecting layer, and patterns between the polarizer and the reflecting layer are used to represent the polarization states of the light.

Exemplarily, the ambient light is incident on the polarizer, and becomes to linearly polarized light after passing through the polarizer. The linearly polarized light is incident on the quarter-slide and the liquid crystals. Under the phase delay of the quarter-slide, the polarization direction of the linearly polarized light is changed by 45 degrees, and the linearly polarized light becomes circularly polarized light. In this case, the polarization direction of the circularly polarized light incident on the reflecting layer is different from the polarization direction of the linearly polarized light exiting out of the polarizer by 45 degrees. Further, the circularly polarized light incident on the reflecting layer may be reflected on the reflecting layer and then is incident on the liquid crystals and the quarter-slide again. Under the phase delay of the quarter-slide, the polarization direction of the circularly polarized light is changed by 45 degrees again, and the circularly polarized light becomes linearly polarized light. In this case, the polarization direction of the linearly polarized light incident on the polarizer is different from the polarization direction of the linearly polarized light exiting out of the polarizer by 90 degrees. That is, the polarization direction of the linearly polarized light incident on the polarizer is perpendicular to (not parallel to) the polarization direction of the linearly polarized light exiting out of the polarizer. The linearly polarized light incident on the polarizer cannot pass through the polarizer and then cannot exit out from a side, away from the reflecting layer, of the polarizer, such that there is no light exiting out of the pixel region, thereby achieving the off-state shown in FIG. 4.

That is, under the actions of the liquid crystals, the quarter-slide and the polarizer, the on-state and the off-state of the pixel region in the reflective display panel may be achieved, thereby controlling the reflective display panel to display an image.

The thin film transistor 14 may include a plurality of functional film layers.

Optionally, referring to FIGS. 2A and 5B, the plurality of functional film layers may include: a gate electrode layer 141, a gate insulating layer 142, an active layer 143, a source and drain electrode layer 144 and a passivation layer 145. The reflectivity of the functional film layer (such as the gate electrode layer), close to the second base substrate 12, in the plurality of functional film layers is lower than the reflectivity of the other functional film layers. The other functional film layers may be any of the plurality of functional film layer (such as the gate insulating layer, the active layer, the source and drain electrode layer and the passivation layer) other than the functional film layer close to the second base substrate. Exemplarily, the reflectivity of the functional film layer (such as the gate electrode layer), close to the second base substrate, in the plurality of functional film layers is lower than 10%.

Alternatively, referring to FIGS. 2B and 5C, the thin film transistor 14 may include a plurality of functional film layers. The plurality of functional film layers may include: a gate electrode layer 141, a gate insulating layer 142, an active layer 143, a source and drain electrode layer 144 and a passivation layer 145. A preset film layer C is arranged at a side, close to the first base substrate 11, of the second base substrate 12. The thin film transistor 14 and the lead 15 are arranged at a side, close to the first base substrate 11, of the preset film layer C. It should be noted that an orthographic projection region of the thin film transistor 14 on the second base substrate 12 may coincide with an orthographic projection region of the preset film layer C on the second base substrate 12. That is, the preset film layer may be used to shield the thin film transistor 14. Herein, the reflectivity of the preset film layer is lower than the reflectivity of any functional film layer (such as the gate electrode layer, the gate insulating layer, the active layer, the source and drain electrode layer or the passivation layer) in the plurality of functional film layers. Exemplarily, the reflectivity of the preset film layer C is lower than 10%.

That is, in the embodiments of the present disclosure, the second base substrate is arranged at the display side of the reflective display panel, and a light source of the reflective display panel is ambient light. In order to improve the utilization of the ambient light in the reflective display panel, it needs to set the reflectivity of the film layer which is in contact with the second base substrate in the plurality of film layers at a side, close to the first base substrate, of the second base substrate to be lower than the reflectivity of the other film layers, thereby enabling more ambient lights to be incident on the reflective display panel.

Further, as shown in FIG. 2A or FIG. 2B, a color film layer 19 may be arranged at a side, close to the second base substrate 12, of the reflecting layer 13. The liquid crystals 16 are located between the color film layer 19 and the thin film transistor 14. That is, the color film layer is arranged at a side, close to the second base substrate, of the reflecting layer, such that the reflective display panel can display a color image.

The reflective display panel may further include a pixel electrode D arranged on the second base substrate, and a common electrode E arranged at a side, close to the second base substrate 12, of the color film layer 19. Herein, a plurality of pixel electrodes D may be arranged on the second base substrate. The plurality of pixel electrodes D are connected with the plurality of thin film transistors 14 in a one-to-one correspondence manner. Both the pixel electrode D and the common electrode E may be made of a transparent conductive material such as indium tin oxide.

To sum up, in the reflective display panel provided in the embodiments of the present disclosure, the reflecting layer is arranged on the first base substrate, and the thin film transistor and the lead are arranged on the second base substrate. Therefore, the display side of the reflective display panel is a side, away from the first base substrate, of the second base substrate. The second base substrate is relatively large in area and may completely cover the first base substrate, thus there is no need to cover the display side of the reflective display panel with a frame when the reflective display panel is packaged, thereby reducing the waste of housing materials and achieving the frameless display side of the reflective display panel.

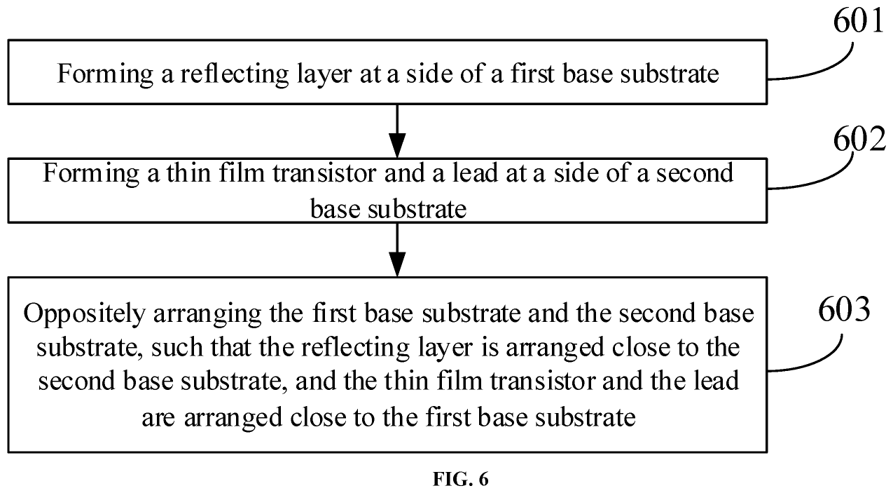

FIG. 6 is a flowchart of a manufacturing method of a reflective display panel according to an embodiment of the present disclosure. This method may be used to manufacture the reflective display panel shown in FIG. 1. As shown in FIG. 6, the manufacturing method of the reflective display panel may include the following steps.

In step 601, a reflecting layer is formed at a side of a first base substrate.

In step 602, a thin film transistor and a lead are formed at a side of a second base substrate.

In step 603, the first base substrate and the second base substrate are oppositely arranged, such that the reflecting layer is arranged close to the second base substrate, and the thin film transistor and the lead are arranged close to the first base substrate.

To sum up, in the reflective display panel manufactured by using the manufacturing method of the reflective display panel provided in the embodiments of the present disclosure, the reflecting layer is arranged on the first base substrate, and the thin film transistor and the lead are arranged on the second base substrate. Therefore, the display side of the reflective display panel is a side, away from the first base substrate, of the second base substrate. The second base substrate is relatively large in area and may completely cover the first base substrate, thus there is no need to cover the display side of the reflective display panel with a frame when the reflective display panel is packaged, thereby reducing the waste of housing materials and achieving the frameless display side of the reflective display panel.

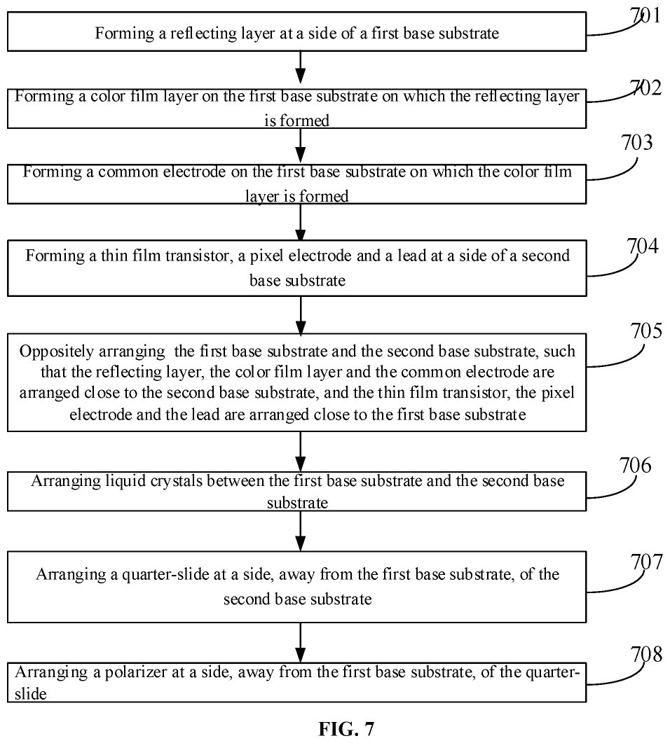

FIG. 7 is a flowchart of another manufacturing method of a reflective display panel according to an embodiment of the present disclosure. The manufacturing of the reflective display panel shown in FIG. 2A is taken as an example in the embodiments of the present disclosure. As shown in FIG. 7, the manufacturing method of the reflective display panel may include the following steps.

In step 701, a reflecting layer is formed at a side of a first base substrate.

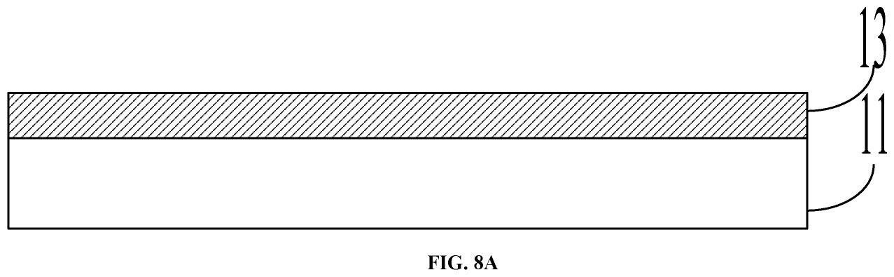

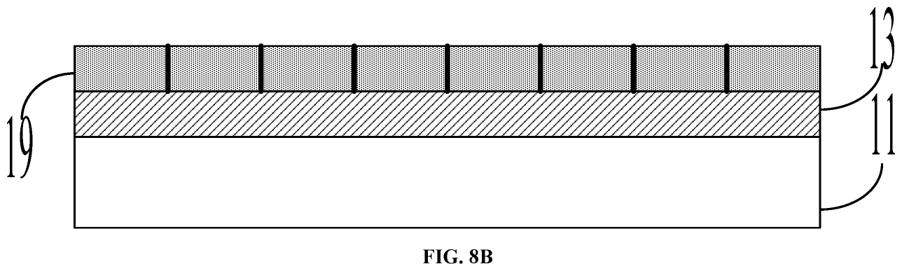

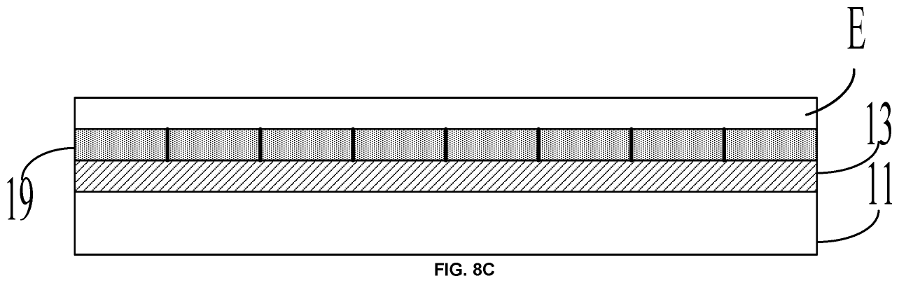

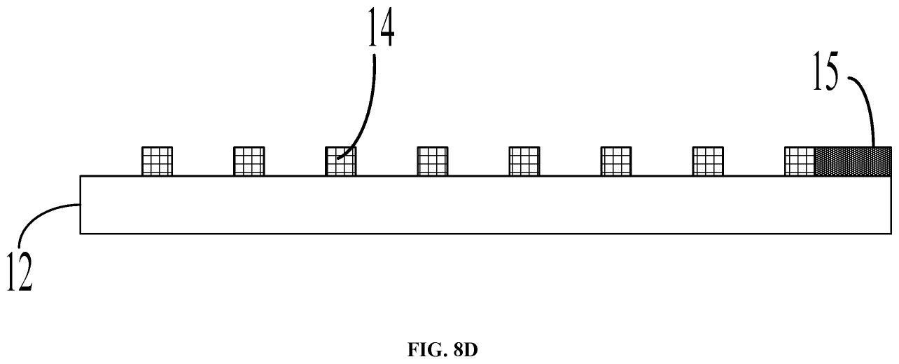

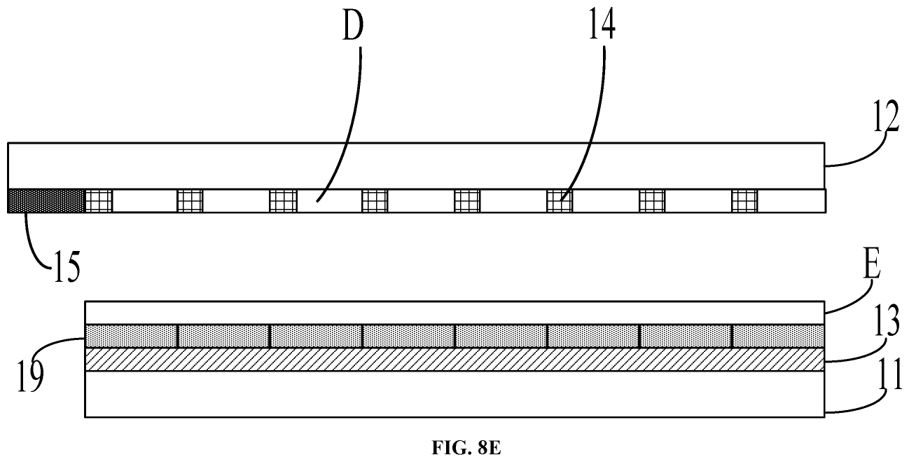

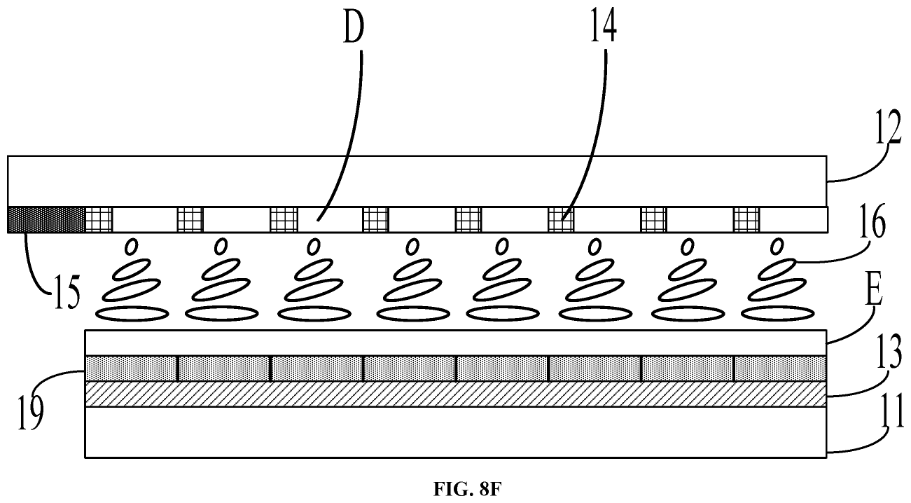

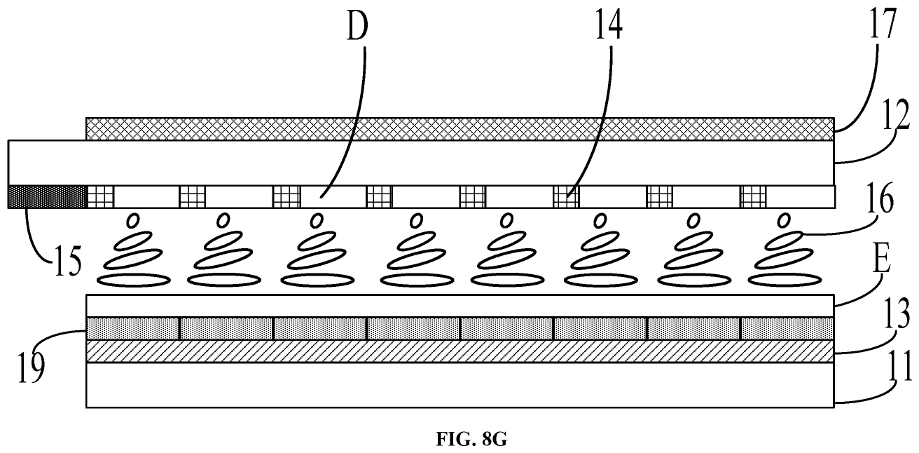

FIG. 8A is a schematic diagram of a first partial structure of a reflective display panel according to an embodiment of the present disclosure. As shown in FIG. 8A, when the reflective display panel is manufactured, the reflecting layer 13 may be formed at a side of the first base substrate 11 in a manner of coating, sputtering or the like. The reflecting layer 13 may overspread the first base substrate 11.

In step 702, a color film layer is formed on the first base substrate on which the reflecting layer is formed.

FIG. 8B is a schematic diagram of a second partial structure of a reflective display panel according to an embodiment of the present disclosure. As shown in FIG. 8B, after the reflecting layer 13 is obtained on the first base substrate 11, the color film layer 19 may further be formed on the first base substrate 11 on which the reflecting layer 13 is formed. Specific steps of forming the color film layer may make reference to specific steps of forming the color film layer in the related art, which are not described herein.

In step 703, a common electrode is formed on the first base substrate on which the color film layer is formed.

FIG. 8C is a schematic diagram of a third partial structure of a reflective display panel according to an embodiment of the present disclosure. As shown in FIG. 8C, after the color film layer is obtained on the first base substrate 11, the common electrode E may further be formed on the first base substrate 11 on which the color film layer 19 is formed. The common electrode E may be made of a transparent conductive material such as indium tin oxide.

In step 704, a thin film transistor, a pixel electrode and a lead are formed at a side of a second base substrate.

FIG. 8D is a schematic diagram of a fourth partial structure of a reflective display panel according to an embodiment of the present disclosure. As shown in FIG. 8D, when the reflective display panel is manufactured, the thin film transistor 14, the pixel electrode D and the lead 15 may further be formed at a side of the second base substrate 12, respectively.

Optionally, the second base substrate has a display region and a bonding region. When the thin film transistor and the lead are formed at a side of the second base substrate, the thin film transistor may be formed in the display region at a side of the second base substrate, and the lead is formed in the bonding region at a side of the second base substrate.

Exemplarily, the thin film transistor may include a plurality of functional film layers. On the one hand, the reflectivity of the functional film layer, close to the second base substrate, in the plurality of functional film layers is lower than the reflectivity of the other functional film layers. The other functional film layers may be any of the plurality of functional film layers other than the functional film layer close to the second base substrate. Specific steps of forming the thin film transistor 14, the pixel electrode D and the lead 15 at a side of the second base substrate may make reference to specific steps in the related art, but it should be noted that during the manufacturing of the thin film transistor, the functional film layer close to the second base substrate is made of a low-reflectivity material.

On the other hand, when the embodiment of the present disclosure is implemented for manufacturing the reflective display panel shown in FIG. 2B, a preset film layer may further be formed at a side of the second base substrate firstly before the thin film transistor, the pixel electrode and the lead are formed; and then the thin film transistor, the pixel electrode and the lead may be formed on the second base substrate on which the preset film layer is formed. Herein, an orthographic projection region of the thin film transistor on the second base substrate may coincide with an orthographic projection region of the preset film layer on the second base substrate. The reflectivity of the preset film layer is lower than the reflectivity of any functional film layer in the thin film transistor. Exemplarily, specific steps of forming the thin film transistor and the lead on the second base substrate on which the preset film layer is formed may make reference to the related art.

In step 705, the first base substrate and the second base substrate are oppositely arranged, such that the reflecting layer, the color film layer and the common electrode are arranged close to the second base substrate, and the thin film transistor, the pixel electrode and the lead are arranged close to the first base substrate.

FIG. 8E is a schematic diagram of a fifth partial structure of a reflective display panel according to an embodiment of the present disclosure. After the reflecting layer 13, the color film layer 19 and the common electrode E are formed on the first base substrate 11, and the thin film transistor 14, the pixel electrode D and the lead 15 are formed on the second base substrate 12, the first base substrate 11 and the second base substrate 12 may be oppositely arranged, such that the reflecting layer 13, the color film layer 19 and the common electrode E on the first base substrate 11 are arranged close to the second base substrate 12, and the thin film transistor 14, the pixel electrode D and the lead 15 are arranged close to the first base substrate 11, thus a structure shown in FIG. 8E can be obtained. That is, the reflecting layer 13, the color film layer 19 and the common electrode E are all arranged at a side, close to the second base substrate 12, of the first base substrate 11, and the thin film transistor 14, the pixel electrode D and the lead 15 are all arranged at a side, close to the first base substrate 11, of the second base substrate 12. After the first base substrate and the second base substrate are oppositely arranged, an orthographic projection region of the first base substrate 11 on the second base substrate 12 is a display region of the second base substrate 12.

In step 706, liquid crystals are arranged between the first base substrate and the second base substrate.

FIG. 8F is a schematic diagram of a sixth partial structure of a reflective display panel according to an embodiment of the present disclosure. In the step 706, the liquid crystals 16 may be arranged between the first base substrate 11 and the second base substrate 12 which are oppositely arranged. Specific steps of arranging the liquid crystals may make reference to specific steps of arranging liquid crystals between two substrates in the related art.

In step 707, a quarter-slide is arranged at a side, away from the first base substrate, of the second base substrate.

FIG. 8G is a schematic diagram of a seventh partial structure of a reflective display panel according to an embodiment of the present disclosure. As shown in FIG. 8G, the quarter-slide 17 may be attached to a side, away from the first base substrate 11, of the second base substrate 12.

In step 708, a polarizer is arranged at a side, away from the first base substrate, of the quarter-slide.

As shown in FIG. 2A, in the step 708, after the quarter-slide is arranged, the polarizer 17 may be arranged at a side, away from the first base substrate, of the quarter-slide. Herein, an included angle between a light transmission axis of the polarizer and an optical axis of the quarter-slide is 45 degrees. The optical axis of the quarter-slide is parallel to a long axis of the liquid crystal.

To sum up, in the reflective display panel manufactured by using the manufacturing method of the reflective display panel provided in the embodiments of the present disclosure, the reflecting layer is arranged on the first base substrate, and the thin film transistor and the lead are arranged on the second base substrate. Therefore, the display side of the reflective display panel is a side, away from the first base substrate, of the second base substrate. The second base substrate is relatively large in area and may completely cover the first base substrate, thus there is no need to cover the display side of the reflective display panel with a frame when the reflective display panel is packaged, thereby reducing the waste of housing materials and achieving the frameless display side of the reflective display panel.

There is provided in the embodiments of the present disclosure a display device including the reflective display panel as shown in FIG. 1, FIG. 2A or FIG. 2B.

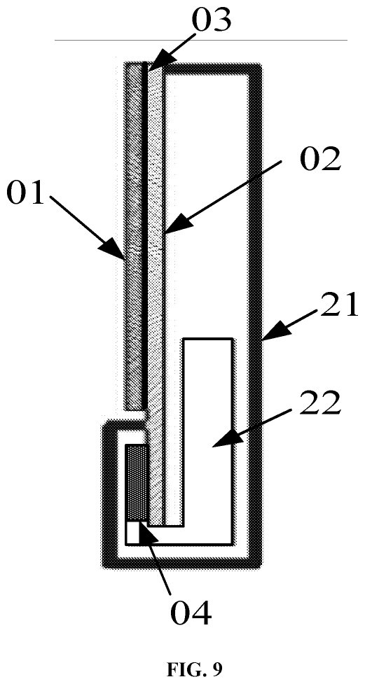

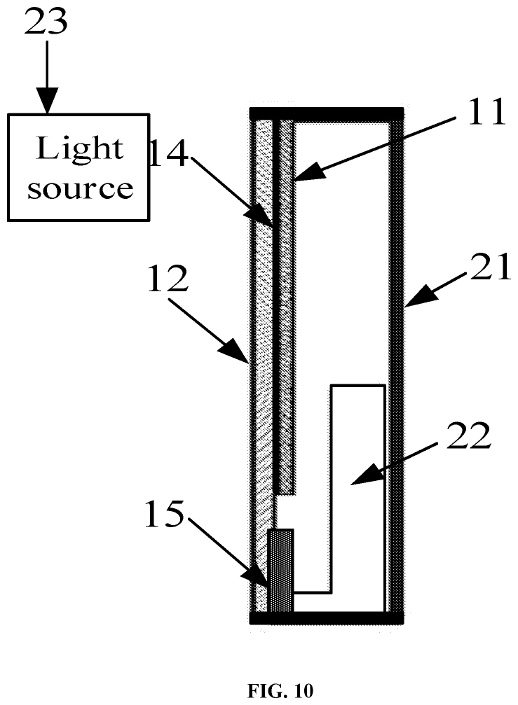

FIG. 9 is a schematic diagram of a structure of a reflective display device provided in the related art. FIG. 10 is a schematic diagram of a structure of a reflective display device according to an embodiment of the present disclosure. It should be noted that FIGS. 9 and 10 merely schematically illustrate schematic diagrams of a simplified structure the reflective display device.

As shown in FIG. 9, the reflective display panel in the related art may include a first base substrate 01 and a second base substrate 02 which are oppositely arranged, and liquid crystals (not shown in FIG. 9) arranged between the first base substrate 01 and the second base substrate 02. A thin film transistor 03 and a lead 04 are arranged at a side, close to the first base substrate 01, of the second base substrate 02. A reflecting layer (not shown in FIG. 9) is arranged at a side, close to the first base substrate 01, of the thin film transistor 03. The thin film transistor 03 is arranged in a display region on the second base substrate 02. The lead 04 is arranged in a bonding region on the second base substrate 02. An orthographic projection region of the first base substrate 01 on the second base substrate 02 coincides with the display region. The lead 04 is connected with a printed circuit board 22. The printed circuit board 22 is connected with the thin film transistor 03 through the lead 04. The printed circuit board 22 is arranged at a side, away from the first base substrate 01, of the second base substrate 02. A display side of the reflective display panel is a side, away from the second base substrate 02 (the base substrate provided with the reflecting layer), of the first base substrate 01. The orthographic projection region of the first base substrate 01 on the second base substrate 02 does not coincide with the bonding region, and thus the first base substrate 01 cannot completely cover the second base substrate 02. When the reflective display panel is packaged, it needs to cover edges of the display side, side surfaces and a back surface of the reflective display panel with a housing 21. Therefore, it needs to use more housing materials when the reflective display panel is packaged, which causes the waste of housing materials.

As shown in FIG. 10, in the embodiments of the present disclosure, the reflecting layer (not shown in FIG. 10) is arranged on the first base substrate 11, and the thin film transistor 14 and the lead 15 are arranged on the second base substrate 12. Therefore, the display side of the reflective display panel is a side, away from the first base substrate 11, of the second base substrate 12. The second base substrate 12 is relatively large in area and may completely cover the first base substrate 11, thus there is no need to cover the display side of the reflective display panel with a frame when the reflective display panel is packaged, thereby reducing the waste of housing materials.

Further, the reflective display device shown in FIG. 10 further includes: a housing 21 and a printed circuit board 22. The printed circuit board 22 is connected with the thin film transistor 14 through the lead 15. The printed circuit board 22 is arranged at a side, away from the second base substrate 12, of the first base substrate 11. An edge of the housing 21 is in contact with a side surface of the second base substrate 12. Structures except for the second base substrate 12, the quarter-slide (not shown in FIG. 10) and the polarizer (not shown in FIG. 10), as well as the printed circuit board 22 are all located between the housing 21 and the second base substrate 12. That is, the structures between the second base substrate 12 and the printed circuit board 22 as well as the printed circuit board 22 are all located between the housing 21 and the second base substrate 12.

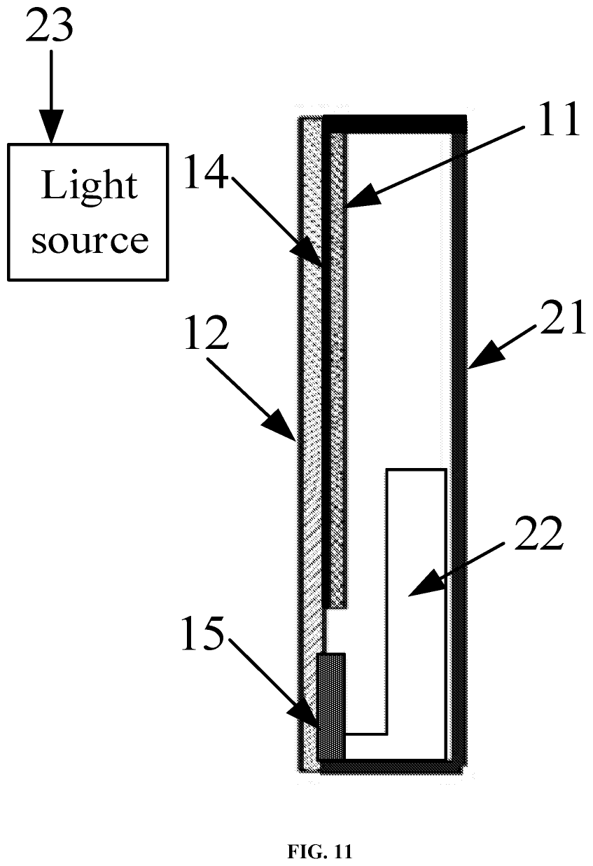

Optionally, as shown in FIG. 11, the edge of the housing 21 in FIG. 10 may also be not in contact with the side surface of the second base substrate 12, but in contact with the surface, close to the first base substrate 11, of the second base substrate 12. In this case, the structures between the second base substrate 12 and the printed circuit board 22 as well as the printed circuit board 22 are all located between the housing 21 and the second base substrate 12.

Optionally, with reference to FIG. 10 or 11, the display device may further include a light source 23. The light source 23 may be arranged at a side, away from the first base substrate 11, of the second base substrate 12 and is configured to emit light to the reflective display panel. That is, the ambient light, according to which the reflective display panel in the display device emits light, may be light emitted by the light source.

To sum up, in the reflective display panel in the reflective display device provided in the embodiments of the present disclosure, the reflecting layer is arranged on the first base substrate, and the thin film transistor and the lead are arranged on the second base substrate. Therefore, the display side of the reflective display panel is a side, away from the first base substrate, of the second base substrate. The second base substrate is relatively large in area and may completely cover the first base substrate, thus there is no need to cover the display side of the reflective display panel with a frame when the reflective display panel is packaged, thereby reducing the waste of housing materials and achieving the frameless display side of the reflective display panel.

It should be noted that the method embodiments, the display panel embodiments and the display device embodiments provided in the embodiments of the present disclosure may make reference to one another, which is not limited in the embodiments of the present disclosure. The order of steps in the method embodiments provided in the embodiments of the present disclosure may be adjusted properly, and the steps may also be correspondingly added or deleted according to the situation. Any variation of method that would be readily conceived by any person skilled in the art within the scope of the technology disclosed in the present disclosure shall fall into the protection scope of the present disclosure, which is not described herein.

The foregoing descriptions are merely exemplary embodiments of the present disclosure, and are not intended to limit the present disclosure. Within the spirit and principles of the disclosure, any modifications, equivalent substitutions, improvements, etc., shall fall into the protection scope of the appended claims of the present disclosure.

1. A reflective display panel comprising a first base substrate and a second base substrate which are opposite to each other,
wherein a reflecting layer is on a side, close to the second base substrate, of the first base substrate, and a thin film transistor and a lead are on a side, close to the first base substrate, of the second base substrate.

2. The reflective display panel according to claim 1, further comprising liquid crystals between the first base substrate and the second base substrate,
wherein a quarter-slide is on a side, away from the first base substrate, of the second base substrate;
a polarizer is on a side, away from the first base substrate, of the quarter-slide; and
an included angle between a light transmission axis of the polarizer and an optical axis of the quarter-slide is 45 degrees, and the optical axis of the quarter-slide is parallel to a long axis of the liquid crystal.

3. The reflective display panel according to claim 1, wherein the thin film transistor comprises a plurality of functional film layers;
a reflectivity of the functional film layer, close to the second base substrate, in the plurality of functional film layers is lower than reflectivities of the other functional film layers; and the other functional film layers are any of the plurality of functional film layers other than the functional film layer close to the second base substrate.

4. The reflective display panel according to claim 3, wherein the reflectivity of the functional film layer, close to the second base substrate, in the plurality of functional film layers is lower than 10%.

5. The reflective display panel according to claim 1, wherein the thin film transistor comprises a plurality of functional film layers; a film layer is on the side, close to the first base substrate, of the second base substrate; the thin film transistor and the lead are on a side, close to the first base substrate, of the film layer;
wherein an orthographic projection region of the thin film transistor on the second base substrate coincides with an orthographic projection region of the film layer on the second base substrate; and the reflectivity of the film layer is lower than the reflectivity of any of the plurality of functional film layers.

6. The reflective display panel according to claim 5, wherein the reflectivity of the film layer is lower than 10%.

7. The reflective display panel according to claim 2, wherein a color film layer is on a side, close to the second base substrate, of the reflecting layer; and the liquid crystals are between the color film layer and the thin film transistor.

8. The reflective display panel according to claim 1, wherein the second base substrate has a display region and a bonding region;
the thin film transistor is in the display region, and the lead is in the bonding region;
an orthographic projection region of the first base substrate on the second base substrate is the display region; and the reflecting layer overspreads the first base substrate.

9. A manufacturing method of a reflective display panel, comprising the following steps:
forming a reflecting layer on a side of a first base substrate;
forming a thin film transistor and a lead on a side of a second base substrate; and
arranging the first base substrate and the second base substrate oppositely, such that the reflecting layer is arranged close to the second base substrate, and the thin film transistor and the lead are arranged close to the first base substrate.

10. The method according to claim 9, further comprising the following steps after the step of arranging the first base substrate and the second base substrate oppositely:
arranging liquid crystals between the first base substrate and the second base substrate;
arranging a quarter-slide at a side, away from the first base substrate, of the second base substrate; and
arranging a polarizer at a side, away from the first base substrate, of the quarter-slide,
wherein an included angle between a light transmission axis of the polarizer and an optical axis of the quarter-slide is 45 degrees, and the optical axis of the quarter-slide is parallel to a long axis of the liquid crystal.

11. The method according to claim 9, wherein the thin film transistor comprises a plurality of functional film layers;
a reflectivity of the functional film layer, close to the second base substrate, in the plurality of functional film layers is lower than reflectivities of the other functional film layers; and the other functional film layers are any of the plurality of functional film layers other than the functional film layer close to the second base substrate.

12. The method according to claim 11, wherein the reflectivity of the functional film layer, close to the second base substrate, in the plurality of functional film layers is lower than 10%.

13. The method according to claim 9, wherein the thin film transistor comprises a plurality of functional film layers; the step of forming the thin film transistor and the lead at the side of the second base substrate comprises the following steps:
forming a film layer at the side of the second base substrate, and
forming the thin film transistor and the lead on the second base substrate on which the film layer is formed;
wherein an orthographic projection region of the thin film transistor on the second base substrate coincides with an orthographic projection region of the film layer on the second base substrate; and a reflectivity of the film layer is lower than the reflectivities of any of the functional film layers in the thin film transistor.

14. The method according to claim 13, wherein the reflectivity of the film layer is lower than 10%.

15. The method according to claim 10, further comprising the following step after the step of forming the reflecting layer at the side of the first base substrate:
forming a color film layer at a side, away from the first base substrate, of the reflecting layer,
wherein after the step of arranging liquid crystals between the first base substrate and the second base substrate, the liquid crystals are between the color film layer and the thin film transistor.

16. The method according to claim 9, wherein the reflecting layer overspreads the first base substrate; the second base substrate has a display region and a bonding region; after the step of arranging the first base substrate and the second base substrate oppositely, an orthographic projection region of the first base substrate on the second base substrate is the display region; and the step of forming the thin film transistor and the lead at the side of the second base substrate comprises the following steps:
forming the thin film transistor in the display region on the side of the second base substrate, and
forming the lead in the bonding region on the side of the second base substrate.

17. A display device comprising a reflective display panel, wherein the reflective display panel comprises: a first base substrate and a second base substrate which are opposite to each other;
a reflecting layer is on a side, close to the second base substrate, of the first base substrate; and a thin film transistor and a lead are on a side, close to the first base substrate, of the second base substrate.

18. The display device according to claim 17, further comprising a housing and a printed circuit board,
wherein the printed circuit board is connected with the thin film transistor through the lead, and is on a side, away from the second base substrate, of the first base substrate;
an edge of the housing is in contact with a side surface of the second base substrate; and structures between the second base substrate and the printed circuit board as well as the printed circuit board are all between the housing and the second base substrate.

19. The display device according to claim 17, further comprising a housing and a printed circuit board,
wherein the printed circuit board is connected with the thin film transistor through the lead, and is on the side, away from the second base substrate, of the first base substrate;
an edge of the housing is in contact with the surface, close to the first base substrate, of the second base substrate; and structures between the second base substrate and the printed circuit board as well as the printed circuit board are all between the housing and the second base substrate.

20. The display device according to claim 17, further comprising a light source,
wherein the light source is on a side, away from the first base substrate, of the second base substrate and is configured to emit light to the reflective display panel.
